(19) United States
(12) Patent Application Publication
(10) Pub. No.: US 2022/0164648 A1
(43) Pub. Date: May 26, 2022

(54) CLUSTERING METHOD BASED ON SELF-DISCIPLINE LEARNING SDL MODEL

(71) Applicant: Zecang GU, Kitakyushu-city (JP)

(72) Inventor: Zecang GU, Kitakyushu-city (JP)

(21) Appl. No.: 17/105,555

(22) Filed: Nov. 26, 2020

(51) Int. Cl. G06N 3/08; G06N 3/04

(52) U.S. Cl. CPC G06N 3/08; G06N 3/04

(57) ABSTRACT

A method for simulating a deep learning model of function mapping uses algorithms that can be calculated numerically. In a functional mapping model of simulated deep learning by an algorithm, a SDL model enables fusion with a Gaussian distribution model. By combining two Gaussian distribution models and the mapping of functions, both features can be exhibited, and a powerful artificial intelligence model can be constructed. The SDL model clustering algorithm is the fusion of the function mapping model and the Gaussian distribution model. The simulation method does not need a combination method as in conventional deep learning to obtain the training data to be identified. Thus, the support of big hardware such as GPU-like deep learning is not needed, black box problems do not occur, and there is no need for enormous data annotation work. Using small amount of training data can get the results of large data set training and achieve lower costs.

### BACKGROUND OF THE INVENTION

The “deep learning” (Neural Information Processing Systems 25: pp 1097-1105 (2012)) proposed by Professor Hinton of University of Toronto in Canada has achieved excellent results in the test data sets of Image_NET image classification, which has attracted the world's attention, thus setting off the climax of this artificial intelligence. Many researchers try to use the “deep learning” model to control the automatic driving vehicle. The representative method is “learning to drive in one day” (arXiv:1807.00412v2.[cs.LG] 11 Sep. (2018)).

Hinton, an inventor of “deep learning”, received an interview with the Axios website in September 2017, saying, “my point is to abandon it and Start all again.” This is because the dream of Hinton's Boltzmann machine shattered, and the black box problem of “deep learning” cannot be solved, and it is not suitable for wide spread, and finally ends.

Therefore, people urgently need to find a new generation of artificial intelligence model instead of “deep learning”, hoping to get a machine learning model with small data, probability, iteration and without black box problem. Therefore, the Capsule theory predicted by Hinton (arXiv:1710.09829v2.[cs.CV] 7 Nov. (2017)) has been paid attention to by the world for a period of time.

After the deep learning was denied by the inventor, the algorithmic school rose rapidly. A new generation of artificial intelligence Self-Discipline Learning (SDL) model entitled “a construction method of artificial intelligence Super deep learning model” (JP 2017-212246) has also been highly concerned by the industry.

The above deep learning model in order to obtain the global optimal solution, exhaustive search is needed. In such a large combinatorial space, this is a NPC problem. Moreover, the local optimal solution obtained by SGD is random for deep learning, and it cannot guarantee that every SGD solution has the best application effect. As the global optimal solution is impossible to obtain, the local optimal solution of SGD is very unstable. As long as the data fluctuates a little, the completely different solution will be obtained, which is the reason for the black box problem.

Also, in large scale processing, huge hardware expenditures are consumed, the processing efficiency is very low, and the hardware cost becomes very high. Since the deep learning is a function mapping model, in the practical application of deep learning, an algorithm staff should be equipped with 100 tagging personnel. This is completely “artificial intelligence”, and the application cost is very high. And, the deep learning is restricted to the application range, It is only common in the field of image recognition and speech recognition, and it cannot be applied to the industrial control and the control of the autopilot car.

The model-free deep reinforcement learning algorithm is adopted, and the deep deterministic policy gradients (deep deterministic policy gradients, DDPG) is used to solve the lane tracking task. In the face of complex automatic driving vehicle control, this method is easy to fall into the control of NPC problem, which is very difficult in practical engineering application.

The capsule theory of the above is a method of increasing the weighted value for information of effective nodes. The weighted value is reduced for the bad nodes information, and calculating the result in a formulaic way. Therefore, its excellent result is still not possible, and to achieve the true probability model and the strong iterative effect that Hinton himself wanted is not yet available.

The SDL model is a mathematical model of the stochastic model of the Gaussian process. Using few data can be used to obtain an infinite set of data sets corresponding to functional mappings. The system scale can be expanded infinitely, and the complexity of the calculation is almost linear. It is also applicable to any field. However, unlike the function mapping model of deep learning, there is no feature that the interval between feature vectors can be enlarged.

### BRIEF SUMMARY OF THE INVENTION

The first purpose of the present invention is to provide a method for simulated a deep learning model of a function mapping using the algorithms that can be calculated numerically. In the perform data training, it is not necessary to find the solution of the best combination of big data space. To improve efficiency, reduce hardware overhead, and solve black box problem.

The second purpose of the present invention is to submit a functional mapping model of simulated deep learning by an algorithm, and the SDL model of enabling fusion with a Gaussian distribution model. By combining two models of the Gaussian distribution and the mapping of functions, both features can be exhibited, and the most powerful artificial intelligence model can be constructed at present, and the spread of artificial intelligence can be promoted.

In order to realize at least one of the above purposes, the invention provides the following technical solutions:

(1) At least one form of information including eigenvector value or Gaussian distribution of eigenvector value is mapped to data set layer by mapping function;
(2) Through clustering algorithm of SDL model, the probability space of the maximum probability obtained by each eigenvector value will be the result of Gaussian distribution representing, that is, the maximum probability value and the maximum probability scale. The maximum probability value and maximum probability scale value is mapped to the data set layer through the mapping function as the output result;
(3) The all the eigenvectors are mapped to the data set layer through the mapping function, then, between the data set layer and neural layer, the probability space with the maximum probability is obtained through the probability scale self-organization. The result of Gaussian distribution representing the maximum probability space, that is, the maximum probability value and maximum probability scale value is to output.

The clustering algorithm of SDL model is the fusion of function mapping model and Gaussian distribution model; the optimal clustering of feature vectors is carried out through the probability scale self-organization and the distances of probability space; the clustering of the results of each probability space of the eigenvalue is directly given.

The mapping function refers to including linear function, non-linear function, and random function, at least one of various mixed mapping functions.

The mapping function refers to not only the classical linear function, the classical nonlinear function, the classical random function, especially according to the characteristics of the solution solved by the deep learning SDG, considering the effect of deep learning on improving the accuracy of pattern recognition The mapping function includes the components of mathematical operation form, membership function, rule construction component, at least one clustering component of SDL model, or a mixture of multiple components.

The probability value and the probability scale are obtained by the probability scale self-organizing algorithm.

A simulation deep learning method based on SDL model is realized through the following steps:

(1) The eigenvalues of information processing objects using modules with probability scale self-organizing, and the maximum probability eigenvalues are input to each node in the sensing layer;
(2) The eigenvalues input to each node of the sensing layer are mapped to the data set layer through the mapping function. Or the training data of multiple eigenvalues are input into the sensing layer, and using clustering algorithm of SDL model, eigenvalues data are trained by the probability scale self-organizing module between the perception layer and the neural layer. And the result can represent the Gaussian distribution of the maximum probability training value or the maximum probability scale value. And then the result of the Gaussian distribution is mapped to the large data set layer by the function mapping method. Or the multiple training data of the eigenvalues is mapped to the data set layer, using clustering algorithm of SDL model between the data set layer and the neural layer. The maximum probability values and maximum probability scale of the Gaussian distribution can be obtained as the output values of neural network.

The clustering algorithm of SDL model is the fusion of function mapping model and Gaussian distribution model; the optimal clustering of feature vectors is carried out through the probability scale self-organization and the distances of probability space; the clustering of the results of each probability space of the eigenvalue is directly given.

The mapping function refers to including linear function, non-linear function, and random function, at least one of various mixed mapping functions.

The mapping function refers to not only the classical linear function, the classical nonlinear function, the classical random function, especially according to the characteristics of the solution solved by the deep learning SDG, considering the effect of deep learning on improving the accuracy of pattern recognition The mapping function includes the components of mathematical operation form, membership function, rule construction component, at least one clustering component of SDL model, or a mixture of multiple components.

The probability value and the probability scale are obtained by the probability scale self-organizing algorithm.

### Merit and Positive Effect of the Present Invention

The simulation method of the deep learning model using the algorithm proposed in the present invention does not need a combination method as in the conventional deep learning, in order to obtain the training data to be identified. The present invention uses only the algorithm of the mapping function, it doesn't need the support of big hardware such as GPU like deep learning. Which does not produce a black box problem, and there is no need for enormous data annotation work. Using small amount of training data can get the results of large data set training. the cost is low, and it is wide and easy to spread.

### BRIEF DESCRIPTION OF THE DRAWINGS

FIG. 1 Minimum network structure of neural networks;

FIG. 2 An example of the relationship between the solution of all the SGD obtained by the input information and the application effect.

FIG. 3 A gradation conversion image processing method;

FIG. 4 An image processing method to highlight edge information;

FIG. 5 An another image processing method to highlight edge information;

FIG. 6 A configuration diagram for simulating deep learning based on SDL model;

FIG. 7 An another configuration diagram for simulating deep learning based on SDL model;

FIG. 8 A schematic diagram to mapping functions of various forms;

FIG. 9 Schematic diagram to two overlapping Gaussian distribution;

FIG. 10 The same class training data in data set of image_NET;

FIG. 11 The flow chart of clustering algorithm for SDL model;

FIG. 12 A schematic diagram of deep separation convolution;

FIG. 13 A schematic diagram of deep separable convolution when more features need to be extracted.

### DETAILED DESCRIPTION

A detailed description with the above drawing is made to further illustrate the present disclosure. As described below, embodiments of the present disclosure will be described in more detail with reference to the accompanying drawings, but embodiments of the present disclosure are illustrative and not limiting.

First, we introduce new definitions, new concepts, and new formulas for the present invention.

[Probability Scale Self-Organization]

Let the probability space be

[symbol]

∈ [symbol] ( [symbol] =1,2, . . . ζ) [Formula 1]

For any initial Gaussian distribution, we can always calculate the expected value [symbol] ⁽⁰⁾ and variance [symbol] ⁽⁰⁾ of this Gaussian distribution. Taking [symbol] ⁽⁰⁾ as the initial maximum probability scale and [symbol] ⁽⁰⁾ as the center value, the data greater than [symbol] ⁽⁰⁾ will be eliminated and those less than [symbol] ⁽⁰⁾ will be reserved, thus forming a new space G⁽¹⁾. The specific expression of iteration is as follows:

[symbol]

⁽ⁿ⁾= [symbol] (G⁽ⁿ⁾)

[symbol]

⁽ⁿ⁾= [symbol] [G⁽ⁿ⁾, [symbol] ⁽ⁿ⁾]

G⁽ⁿ⁺¹⁾=G{ [symbol] (G⁽ⁿ⁾), [symbol] [G⁽ⁿ⁾, [symbol] ⁽ⁿ⁾]} [Formula 2]

According to the results of n iterations, the maximum probability value [symbol] ⁽ⁿ⁾ close to the parent as well as the maximum probability scale [symbol] ⁽ⁿ⁾ and the maximum probability space G⁽ⁿ⁺¹⁾ can be obtained in the above probability space. [The migration and inevitability of Probability scale self-organization]

No matter where the initial region is, the above-mentioned Probability scale self-organization will be able to migrate to the region with the maximum probability of convergence through several iterations.

[Probability Space]

The probability space described here is based on the Soviet mathematician Andrey Kolmogorov's theory that “probability theory is based on measurement theory”. The so-called probability space is a measurable space with a total measure of “1”. According to this theory, lemma 1 can be generated: “there is only one Gaussian distribution in probability space, so there are infinite probability spaces in Euclidean space.

[Probability Space Distance]

Measure the scale from a point in Euclidean space to a probability space, or from one probability space to another.

[The Calculation Method of Probability Space Distance]

Let [symbol] ∈V( [symbol] =1,2, . . . , [symbol] ) be the eigenvalue of the eigenvector set V, the maximum probability value of the probability space is [symbol] , and the maximum probability scale is [symbol] , and another eigenvector set W, eigenvalue [symbol] ∈W( [symbol] =1, 2, . . . , [symbol] ), the maximum probability value of the probability space is [symbol] , and the maximum probability scale [symbol] , and the eigenvector R in Euclidean space, the eigenvalue is [symbol] ∈ [symbol] ( [symbol] =1, 2, . . . , [symbol] ). Then we can unify the distance G(V, W) between Euclidean space and probability space, which can be calculated by the following formula.

$$G ( V , W ) = \{ \sqrt[2]{{\sum }_{i = 1}^{n} {( {ρ}_{{v}_{𝒿}} - {γ}_{𝒿} )}^{2}} \} + \{ \sqrt[2]{{\sum }_{j = 1}^{n} {( {γ}_{𝒿} - {ρ}_{{𝓌}_{𝒿}} )}^{2}} \} = \{ \sqrt[2]{{\sum }_{j = 1}^{n} {( {ρ}_{{𝓋}_{𝒿}} - {ρ}_{{𝓌}_{𝒿}} )}^{2}} \} = \{ \sqrt[2]{{\sum }_{j = 1}^{n} {( {ρ}_{{𝓌}_{𝒿}} - {ρ}_{{𝓋}_{𝒿}} )}^{2}} \} \\ ( {ρ}_{{v}_{𝒿}} - {γ}_{𝒿} ) = \{ \begin{matrix}0 & \vert {ρ}_{{v}_{𝒿}} - {γ}_{𝒿} \vert \leq {ℳ}_{{v}_{𝒿}} \\ \vert {ρ}_{{v}_{𝒿}} - {γ}_{𝒿} \vert - {ℳ}_{{v}_{𝒿}} & \vert {ρ}_{{v}_{𝒿}} - {γ}_{𝒿} \vert > {ℳ}_{{v}_{𝒿}}\end{matrix} \\ ( {γ}_{𝒿} - {ρ}_{{w}_{𝒿}} ) = \{ \begin{matrix}0 & \vert {γ}_{𝒿} - {ρ}_{{w}_{𝒿}} \vert \leq {ℳ}_{{𝓌}_{𝒿}} \\ \vert {γ}_{𝒿} - {ρ}_{{w}_{𝒿}} \vert - {ℳ}_{{𝓌}_{𝒿}} & \vert {γ}_{𝒿} - {ρ}_{{w}_{𝒿}} \vert > {ℳ}_{{𝓌}_{𝒿}}\end{matrix} \\ ( {ρ}_{{v}_{𝒿}} - {ρ}_{{w}_{𝒿}} ) = ( {ρ}_{{w}_{𝒿}} - {ρ}_{{v}_{𝒿}} ) = \{ \begin{matrix}0 & \vert {ρ}_{{v}_{𝒿}} - {ρ}_{{w}_{𝒿}} \vert \leq ( {ℳ}_{{v}_{𝒿}} + {ℳ}_{{𝓌}_{𝒿}} ) \\ \vert {ρ}_{{v}_{𝒿}} - {ρ}_{{w}_{𝒿}} \vert - ( {ℳ}_{{v}_{𝒿}} + {ℳ}_{{𝓌}_{𝒿}} ) & \vert {ρ}_{{v}_{i}} - {ρ}_{{w}_{i}} \vert > ( {ℳ}_{{v}_{𝒿}} + {ℳ}_{{𝓌}_{𝒿}} )\end{matrix} \qquad [ Formula 3 ]$$

Here we provide a way to open the black box of deep learning.

According to the known combination theory, the combination of more than 40 elements is an unsolvable NPC problem of Turing machine. According to this knowledge, we construct a neural network with the smallest scale which can obtain the global optimal solution by exhaustive enumeration.

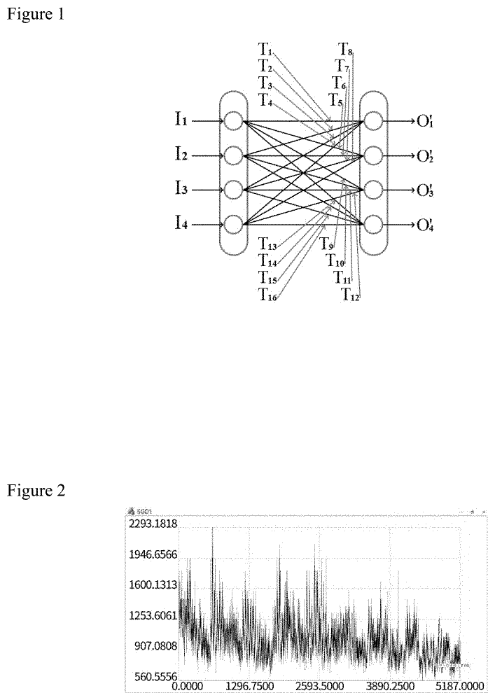

FIG. 1 is a minimum network structure of neural networks

As shown in FIG. 1, I₁, I₂, I₃, I₄ are input information, T₁, T₂, T₃, . . . , T₁₆ are weights, that is, data set of combined results, O₁, O₂, O₃, O₄ are output information. According to the principle of neural network, the

O₁¹=I₁T₁+I₂T₂+I₃T₃+I₄T₄

O₂¹=I₁T₅+I₂T₅+I₃T₇+I₄T₈

O₃¹=I₁T₉+I₂T₁₀+I₃T₁₁+I₄T₁₂

O₄¹=I₄T₁₃+I₂T₁₄+I₃T₁₅+I₄T₁₆ [Formula 4]

Let Oᵢ¹=Iᵢ, Then:

O₁¹=+I₂T′₂+I₃T′₃+I₄T′₄

O₂¹=I₁T′₅+I₃T′₇+I₄T′₈

O₃¹=I₁T′₉+I₂T′₁₀+I₄T′₁₂

O₄¹=I₁T′₁₃+I₂T′₁₄+I₃T′₁₅

As shown in formula 4, this is a system of linear equations, when the input information is equal to the output information, it should have a global optimal solution. Therefore, the system is a stable system in the global optimal solution, and there is no black box problem.

We find a unique global optimal solution by exhaustive method, and prove the correctness of Formula 1. At the same time, according to the principle of SGD, we also use exhaustive method to solve SGD solution. It is found that for such a simple neural network, the number of local optimal solutions of SGD is random with different input information. When it is less, it is hundreds, but when it is more, it may reach more than 20000. Although the occasionally encountered input information can make the solution of SGD advance towards the global optimal solution until the global optimal solution is obtained. But this situation is extremely accidental. Because there are too many SGD solutions, it is very difficult to cross the slope of so many local optimal solutions by SGD method. Therefore, there is no scientific basis for the proponents of SGD method to obtain the global optimal solution through SGD, which is a very wrong theory.

FIG. 2 is shows an example of the relationship between the solution of all the SGD.

After the black box of neural network is opened, through a large number of data, we have a thorough understanding of the mechanism of deep learning. Neural network for input data through the combination of neural network function mapping can enlarge the interval of different eigenvectors to hundreds or even thousands of times, or higher degree. Moreover, this kind of function mapping is the mapping of random functions, and the tiny difference of input information will be mapped to different data sets through random function mapping. Therefore, according to the theory of Gaussian distribution, the probability of misidentification of different types of data sets can be greatly reduced. This is very beneficial to improve the accuracy of image classification and image recognition. The outstanding performance of deep learning in application effect is not determined by the structure of neural network or the form of weight generation. It is determined by the form of function mapping. Function mapping is mapped under a single independent data, so the small difference between feature vectors can get the result of correct mapping and the result of data matching, which is the root of deep learning to obtain the accuracy beyond the traditional recognition.

As shown in FIG. 2, from the solution of the first SGD to the solution of 5187 SGD, the result is random and has several times difference with the application effect. Therefore, the SGD method can not guarantee that the global optimal solution can be obtained, nor can it guarantee that the SGD solution is the best solution for the application of deep learning. Therefore, SGD method is a pseudo proposition.

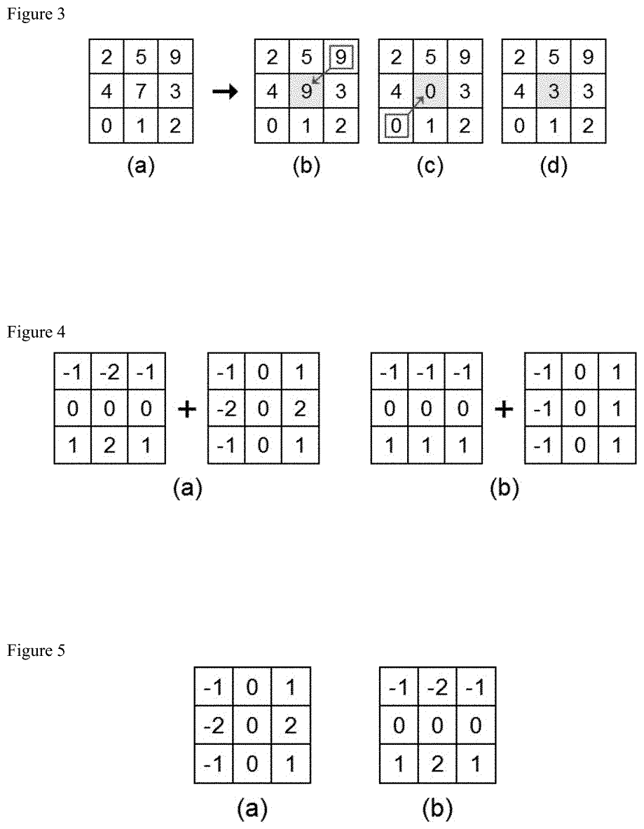

FIG. 3 is a gradation conversion image processing method

As shown in FIG. 3 (a) is the original gray value of any 3*3 pixels in the original image. As shown in (b) of FIG. 3, the maximum gray value of the original gray value of 3*3 pixels is exchanged with the central gray value. As shown in (c) of FIG. 3, the minimum gray value of the original gray value of 3*3 pixels is exchanged with the central gray value. As shown in (d) of FIG. 3, the maximum probability value of each gray value in the original gray value of 3*3 pixels is calculated by Probability scale self-organization, and the maximum probability value is exchanged with the central gray value. As shown in (E) of FIG. 3, the average gray value in the original gray value of 3*3 pixels is exchanged with the central gray value.

FIG. 4 is an image processing method to highlight edge information. As shown in (a) of FIG. 4, the derivative of the image is obtained in X direction and Y direction respectively, and then the gray value of the original pixel is replaced by multiplying the constants in the left and right of 3*3 grids of FIG. 4 (a) according to the correspondence of each pixel. Similarly, as shown in (b) of FIG. 4, the image is derived in X direction and Y direction respectively, and then the gray value of the original pixel is replaced by the result of multiplying the constants in the left and right of 3*3 grids in FIG. 4 (b).

FIG. 5 is another image processing method to highlight edge information Same as FIG. 4, and as shown in FIG. 5, the processing effect of horizontal border filter can be obtained by multiplying the derivative results in X direction with this template. As shown in (b) of FIG. 5, the processing effect of horizontal border filter can be obtained by multiplying the derivative results in Y direction with this template.

In image recognition, an image can be transformed into multiple images, which can form the Gaussian distribution of each feature values, so as to improve the recognition rate and image quality.

Especially in image recognition, the number of feature values can be increased to improve the recognition rate. In particular, convolution kernel, which is often used in deep learning, can also be imported into SDL model which simulates deep learning with algorithm. It can increase the number of feature vectors, increase the interval between feature vectors of different classes of images, and increase the scale of data set. Finally, it can improve the classification accuracy of images and the accuracy of image recognition.

The main convolution algorithms for deep learning are as follows:

1. Gaussian Convolution Kernel

$$\frac{1}{16} [ \begin{matrix}1 & 2 & 1 \\ 2 & 4 & 2 \\ 1 & 2 & 1\end{matrix} ] \frac{1}{273} [ \begin{matrix}1 & 4 & 7 & 4 & 1 \\ 4 & 16 & 26 & 16 & 4 \\ 7 & 26 & 41 & 26 & 7 \\ 4 & 16 & 26 & 16 & 4 \\ 1 & 4 & 7 & 4 & 1\end{matrix} ] \qquad [ Formula 5 ]$$

Corresponding to the pixels of each RGB color image cell, the processing results can be accumulated and averaged again, which can slide one pixel, two, or three, etc.

2. Roberts Edge Detection

$${Roberts}_{135} = [ \begin{matrix}1 & 0 \\ 0 & - 1\end{matrix} ] ( 135 degree image ) \\ or \\ Robert {s}_{45} = [ \begin{matrix}0 & 1 \\ - 1 & 0\end{matrix} ] ( 45 degree image ) \qquad [ Formu1a 6 ]$$

3. Prewitt Edge Detection

$${Prewitt}_{x} = [ \begin{matrix}1 & 0 & - 1 \\ 1 & 0 & - 1 \\ 1 & 0 & - 1\end{matrix} ] ( X direction ) \\ or \\ {Prewitt}_{y} = [ \begin{matrix}1 & 1 & 1 \\ 0 & 0 & 0 \\ - 1 & - 1 & - 1\end{matrix} ] ( Y direction ) \qquad [ Formula 7 ]$$

4. Sobel Detection

$${Sobel}_{x} = [ \begin{matrix}1 & 0 & - 1 \\ 2 & 0 & - 2 \\ 1 & 0 & - 1\end{matrix} ] ( x ) \\ or \\ {Sobel}_{y} = [ \begin{matrix}1 & 2 & 1 \\ 0 & 0 & 0 \\ - 1 & - 2 & - 1\end{matrix} ] ( y ) \qquad [ Formula 4 ]$$

5. Scharr Edge Detection

$${Scharr}_{x} = [ \begin{matrix}3 & 0 & - 3 \\ 10 & 0 & - 10 \\ 3 & 0 & - 3\end{matrix} ] ( X direction ) \\ or \\ {Scharr}_{y} = [ \begin{matrix}3 & 0 & - 3 \\ 10 & 0 & - 10 \\ 3 & 0 & - 3\end{matrix} ] ( Y direction ) \qquad [ Formula 9 ]$$

6. Laplacian Operator

$$[ \begin{matrix}0 & - 1 & 0 \\ - 1 & 4 & - 1 \\ 0 & - 1 & 0\end{matrix} ] [ \begin{matrix}0 & 1 & 0 \\ 1 & - 4 & 1 \\ 0 & 1 & 0\end{matrix} ] [ \begin{matrix}0 & 2 & 0 \\ 2 & - 8 & 2 \\ 0 & 2 & 0\end{matrix} ] \qquad [ Formula 10 ]$$

7. Kirsch Direction Operator

$$[ \begin{matrix}5 & 5 & 5 \\ - 3 & 0 & - 3 \\ - 3 & - 3 & - 3\end{matrix} ] [ \begin{matrix}- 3 & 5 & 5 \\ - 3 & 0 & 5 \\ - 3 & - 3 & - 3\end{matrix} ] [ \begin{matrix}- 3 & - 3 & 5 \\ - 3 & 0 & 5 \\ - 3 & - 3 & 5\end{matrix} ] [ \begin{matrix}- 3 & - 3 & - 3 \\ - 3 & 0 & 5 \\ - 3 & 5 & 5\end{matrix} ] \\ [ \begin{matrix}- 3 & - 3 & - 3 \\ - 3 & 0 & - 3 \\ 5 & 5 & 5\end{matrix} ] [ \begin{matrix}- 3 & - 3 & - 3 \\ 5 & 0 & - 3 \\ 5 & 5 & - 3\end{matrix} ] [ \begin{matrix}5 & - 3 & - 3 \\ 5 & 0 & - 3 \\ 5 & - 3 & - 3\end{matrix} ] [ \begin{matrix}5 & 5 & - 3 \\ 5 & 0 & - 3 \\ - 3 & - 3 & - 3\end{matrix} ] \qquad [ Formula 11 ]$$

8. Relief Filter

$$[ \begin{matrix}- 1 & 0 & 0 \\ 0 & 0 & 0 \\ 0 & 0 & 1\end{matrix} ] [ \begin{matrix}0 & 0 & - 1 \\ 0 & 0 & 0 \\ 1 & 0 & 0\end{matrix} ] [ \begin{matrix}- 1 & 0 & - 1 \\ 0 & 0 & 0 \\ 1 & 0 & 1\end{matrix} ] [ \begin{matrix}2 & 0 & 0 \\ 0 & - 1 & 0 \\ 0 & 0 & - 1\end{matrix} ] \qquad [ Formula 12 ]$$

The noise in the region of the image is filtered.

9. Edge Reinforcement

$$[ \begin{matrix}1 & 1 & 1 \\ 1 & - 7 & 1 \\ 1 & 1 & 1\end{matrix} ] \qquad [ Formula 13 ]$$

10. Average Filter

$$\frac{1}{9} [ \begin{matrix}1 & 1 & 1 \\ 1 & 1 & 1 \\ 1 & 1 & 1\end{matrix} ] \qquad [ Formula 14 ]$$

11. Deep Separable Convolution

FIG. 12 is a schematic diagram of deep separation convolution. As shown in FIG. 12; like neural network, deep separable convolution can also be used in SDL model to perform spatial convolution while keeping channel separation, and then carry out deep convolution. Taking the RGB image with an input image of 12×12×3 as an example, the normal convolution is to check the convolution of three channels at the same time. In other words, three channels, after a convolution, output a number. The depth separable volume integral consists of two steps The first step is to convolute the three channels with three convolutions, so that after one convolution, three numbers are output.

This output of three numbers, and then through a 1×1×3 convolution kernel (pointwise kernel), get a number.

So the depth separable convolution is realized by two convolutions.

The first step is to convolute the three channels and output the attributes of the three channels.

In the second step, the convolution kernel 1×1×3 is used to convolute the three channels again. At this time, the output is the same as the normal convolution, which is 8×8×1.

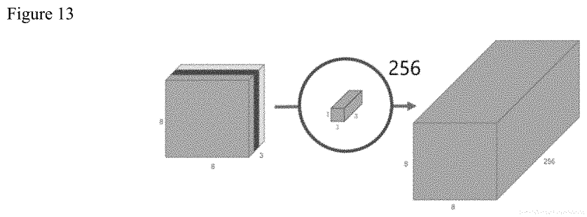

FIG. 13 is a schematic diagram of deep separable convolution when more features need to be extracted.

As shown in FIG. 13, when more features need to be extracted, more 1×1×3 convolution kernels should be designed (for example, the cube of 8×8×256 is drawn as 256 8×8×1, because they are not integrated and represent 256 attributes).

In the 2012_Net image classification, deep learning to excellent results obtained the world attention. In order to prove that the algorithm based simulation deep learning proposed in the invention can surpass the ability of conventional deep learning. The invention also uses image classification of the Image_NET as an example, and provides a more powerful new generation of artificial intelligence model, which uses function Gaussian distribution model and algorithm to simulate deep learning function mapping model.

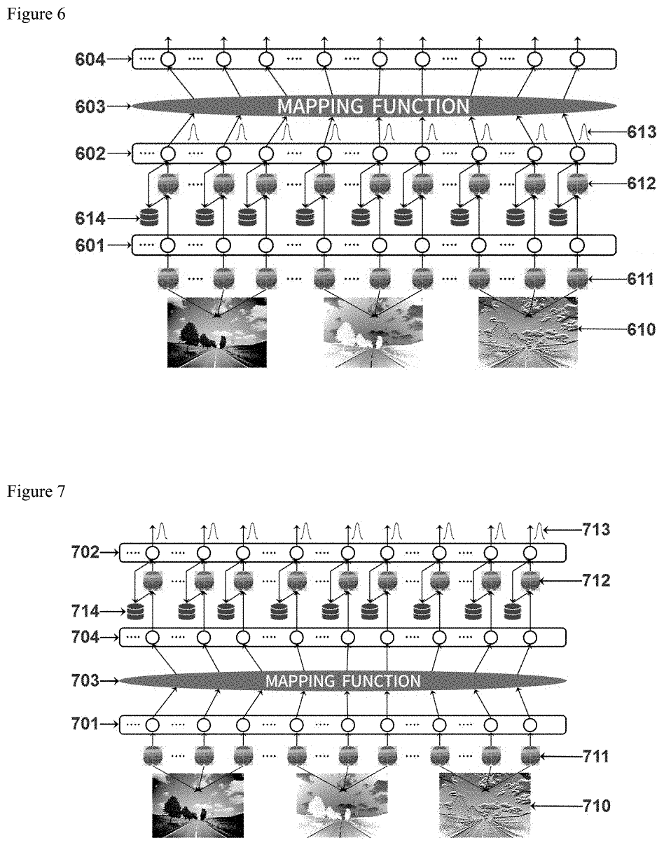

FIG. 6 is a configuration diagram for simulating deep learning based on SDL model.

As shown in FIG. 6, (601) is a perceptual layer, and image information (610) is input through a module of Probability scale self-organization (611) connected to each node of the perceptual layer. As an alternative, there is no need for probability scale self-organization (611), and it is possible to input the image information by above described convolution algorithm as in the case of deep learning. (602) is a nerve layer, the module of the Probability scale self-organization (612) connected between the neural layer (602) and the perceptual layer (601). Using this module, we can classify the probability space of all the feature vectors of many different classes of training images according by the distance of probability space and the maximum probability scale, and obtain the results of Gaussian distribution of each eigenvalue. The result (613) of the Gaussian distribution obtained from the neural layer is mapped onto the data set layer (604) by the mapping function (603). It is possible to simulation deep learning by processing the neural layer and data set layer.

Here, the image information (610) can divide the image into η small ϵ*δ pixel regions. The maximum probability value of the region can be calculated by Probability scale self-organization in each small region, and input to the corresponding node of the perceptual layer. The maximum probability value of each small region constitutes its own eigenvalue. The eigenvalues of the maximum probability value of all small regions of the image constitute the eigenvector of the image.

It can also be exactly the same as deep learning, using convolution algorithm to process each small area of the image, and input the processing results to the corresponding nodes in the perceptual layer (601).

Next, we use mathematical formula to express the principle of image classification and image recognition based on algorithm simulation deep learning.

Suppose that the training data of a images formed by β eigenvalues of each node input to the sensing layer (601) are the same training set images obtained under different conditions, or different classes of images with different training sets data mixed together, such as image_NET, or mix different classes of images together. Through training, the interval of different classes of feature vectors is pulled apart, hereinafter referred to as training image. Its expression is as follows:

$$[ \begin{matrix}{Φ}_{1} \\ {Φ}_{2} \\ … \\ {Φ}_{α}\end{matrix} ] = [ \begin{matrix}{φ}_{11} , {φ}_{12} , … , {φ}_{1 β} \\ {φ}_{21} , {φ}_{22} , … , {φ}_{2 β} \\ … \\ {φ}_{α1} , {φ}_{α2} , … , {φ}_{αβ}\end{matrix} ] \qquad [ Formula 15 ]$$

Through the training of formula (15), in each group of eigenvalues [[φ]_1i [symbol] ,φ [symbol] _2i, . . . , φ_αI] (I=1, 2, . . . , β) can be obtained from (formula 1-2) that γ eigenvector group is composed of β maximum probability eigenvalues

$$[ \begin{matrix}{Φ}_{max 1} \\ {Φ}_{max 2} \\ … \\ {Φ}_{max γ}\end{matrix} ] = [ \begin{matrix}{φ}_{max 11} , {φ}_{max 12} , … , {φ}_{max 1β} \\ {φ}_{max 21} , {φ}_{max 22} , … , {φ}_{max 2β} \\ … \\ {φ}_{max γ1} , {φ}_{max γ2} , … , {φ}_{max γβ}\end{matrix} ] \qquad [ Formula 16 ]$$

Here: γ≤α, and the vector of the maximum probability scale can be obtained from by formula 1-2.

$$[ \begin{matrix}{ℳ}_{max 1} \\ {ℳ}_{max 2} \\ … \\ {ℳ}_{max γ}\end{matrix} ] = [ \begin{matrix}{𝓂}_{max 11} , {𝓂}_{max 12} , … , {𝓂}_{max 1β} \\ {𝓂}_{max 21} , {𝓂}_{max 22} , … , {𝓂}_{max 2β} \\ … \\ {𝓂}_{max γ1} , {𝓂}_{max γ2} , … , {𝓂}_{max γβ}\end{matrix} ] \qquad [ Formula 17 ]$$

According to the above definition of probability space, each element φₘₐₓᵢ and mₘₐₓᵢ con form space of maximum probability.

$$[ \begin{matrix}{𝒮}_{max 1} \\ {𝒮}_{max 2} \\ … \\ {𝒮}_{max γ}\end{matrix} ] = [ \begin{matrix}{s}_{max 11} , {s}_{max 12} , … , {s}_{max 1β} \\ {s}_{max 21} , {s}_{max 22} , … , {s}_{max 2β} \\ … \\ {s}_{max γ1} , {s}_{max γ2} , … , {s}_{max γβ}\end{matrix} ] \qquad [ Formula 18 ]$$

In the Formula 16 and 17, φₘₐₓᵢ and mₘₐₓᵢ are constants for calculate the probability space sₘₐₓᵢⱼ (i=1, 2, . . . , γ, j=1, 2, . . . , β). In the gamma probability space, there are similar images and different classes of images, but the Gaussian distribution interval between the feature vectors of different classes of images must be separated.

The difference between deep learning and the new SDL model which uses algorithm to simulate deep learning proposed in the invention is that deep learning only maps data to data set. The new SDL model can separate the interval of Gaussian distribution of different classes of images, and map the Gaussian distribution to the data set, which has the characteristics of training big data with small data.

As shown in formula 19, in order to improve the recognition accuracy, it is always hoped that the farther the probability space distance between the maximum probability eigenvalues A and B of different classes of images is the better. This problem can be solved by function mapping. Let the mapping function C satisfy the following inequality

| [symbol] (Θ_{μ})Φ^{ζ}− [symbol] (Θ_{μ})Φ^{ξ}|>>|Φ^{ζ}−Φ^{ξ}| [Formula 19]

FIG. 7 is an Another configuration diagram for simulating deep learning based on SDL model.

As shown in FIG. 7, (701) is the perception layer, which is mainly responsible for receiving image feature information (710) through Probability scale self-organization (711) at each node of the sensing layer. (703) is a mapping function, which mainly undertakes to map the feature information of the image output from the sensing layer to the data set layer (704).

The (702) is the neural layer, mainly responsible for the training image of the same class obtained from the data set layer (704). The data set of same class of images (formula 5) is trained by machine learning (712) of the Probability scale self-organization to obtain the maximum probability Gaussian distribution (formula 8) of the eigenvalues of images.

When inputting images of the different class, the maximum probability Gaussian distribution (formula 18) of the eigenvalues of the images of the different classes is obtained by probability scale self-organization (712) training. In this case, if the Gaussian distributions of the two different images have overlapped parts, the maximum probability scale values of the two Gaussian distributions should be compressed.

Finally, the maximum probability value and the maximum probability scale value of the compressed Gaussian distribution (713) are obtained and sent to each node of neural layer (702) as output values.

Here, the image information (710) can divide the image into η small ϵ*δ pixel regions. The maximum probability value of this region can be calculated by Probability scale self-organization in each small region, and input to the corresponding node in the sensing layer. The maximum probability value of each small region constitutes its eigenvalue. The eigenvalues of the maximum probability value of all small regions of the image constitute the eigenvector of the image.

The results of feature extraction can be sent to the nodes in the sensing layer. We can also use the convolution algorithm commonly used in deep learning (formula 5-14) to extract features from each small region of the image, and take the extracted eigenvalues from each small region as a set of eigenvectors, and merge them with the feature vectors introduced above to form a new feature vector.

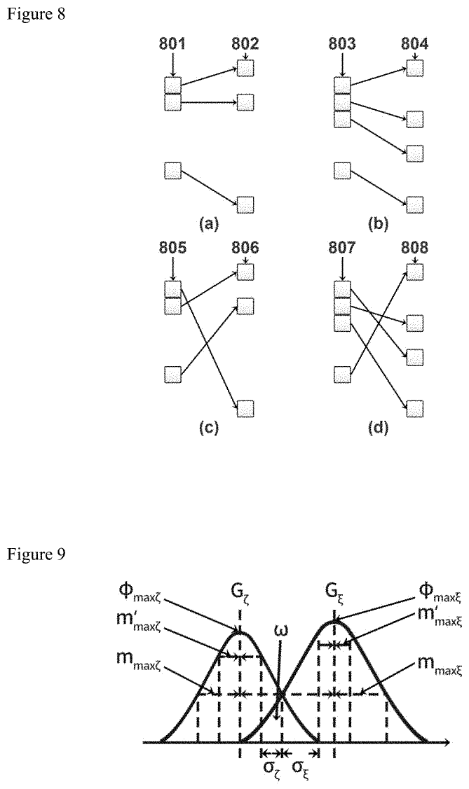

FIG. 8 is a schematic diagram to mapping functions of various forms. [symbol] (Θ_{μ}) (μ=1,2, . . . , θ) can be a linear function, as shown in (a) of FIG. 8. (801) is the eigenvector composed of various eigenvalues, (802) is the result of mapping, and the distance interval of eigenvector (801) can be increased at will through the mapping function of the imitating deep learning. Which is to enlarge the interval of eigenvector after information input is mapped to large data set by imitating the deep learning the effect is achieved.

[symbol] (Θ_{μ}) can also be a non-linear function, as shown in the FIG. 8(b); (803) is the eigenvector composed of various eigenvalues, (804) is the result of mapping, and the eigenvector (803) can be mapped into complex nonlinear results at will through the mapping function. By imitating the incentive function of deep learning, the feature vector mapped to the large data set produces nonlinear effect, which has been used in the corresponding nonlinear data classification.

[symbol] (Θ_{μ}) can also be a random function, as shown in (c) of FIG. 8. (805) is the eigenvector composed of various eigenvalues, and (806) is the result of mapping. Through the mapping function, the eigenvector (805) can be arbitrarily mapped into the result of complex random function, which is the random arrangement of each eigenvalue in the eigenvector, which can imitate the random relationship between SGD and input information.

[symbol] (Θ_{μ}) can also be a composite function composed of at least two of the three functions. As shown in (d) of FIG. 8, (807) is the eigenvector composed of each eigenvalue, and (808) is the mapped result. Through the mapping function, the eigenvector (705) can be mapped into complex, which has both random and nonlinear effects, which is also the feature of the mapping result of deep learning function.

[symbol] (Θ_{μ}) is not only the classical linear function, the classical nonlinear function and the classical random function. Especially according to the characteristics of the solution obtained by the deep learning SDG, considering the effect of deep learning on the accuracy of pattern recognition, combined with human intervention, the mapping function is constructed comprehensively. The mapping function has the components of mathematical operation, membership function, rule construction, etc., which can meet the comprehensive function mapping model.

In order to improve the recognition accuracy, we can enlarge the distance between the feature vectors of different classes of images, so as to distinguish different classes of images. Image feature extraction can be carried out through the template of FIG. 3-5, convolution kernel (formula 5-14, and FIG. 12 and FIG. 13), or a combination of multiple feature extraction methods. Finally, the processing results are input to the nodes of the sensing layer (601 or 701) as new eigenvalues.

FIG. 9 is a schematic diagram to two overlapping Gaussian distribution

As shown in FIG. 9, they are two Gaussian distributions g obtained from two different classes of the images. The overlapped part is w, the maximum probability value and maximum probability scale is Φ_{maxζ} and m_{maxζ} for the Gaussian distribution G_{ζ}, and the maximum probability value and maximum probability scale is Φ_{maxξ} and m_{maxξ} for the Gaussian distribution G_{ξ}.

In the traditional method, after maximum probability value and maximum probability scale value of the Gaussian distribution is obtained using self-organization of probability scale in the training data (formula 15) the feature vector of the sample (formula 18) and Gaussian distribution (formula 16 and 17) of the training data (formula 15) are calculated to obtain the minimum probability space distance, and can determine the result of image recognition.

In this case, it is need to consider the maximization of the distance between the feature vectors of different classes of images, which requires efforts on the quality of feature extraction or the number of feature values, however will be limited in reality.

In the function mapping model, it is unnecessary to consider the maximization of the distance between the feature vectors of different classes of images, as long as each mapped datum exists independently and has interval. It is only necessary to do some processing on the interval of feature vectors of different classes of images.

As shown in FIG. 9, the results of Gaussian distribution of two different images have coincidence region w, which means that there will be possibility of recognition error. If the data of the range of maximum probability scale is mapped to the data set, it is possible to divide class of images into one class.

The present invention considers that classes of images are mixed for the data training. When the Gaussian distribution of classes of images is superimposed as shown in FIG. 9, the maximum probability scale values m_{maxζ} and m_{maxξ} for two Gaussian distributions G_{ζ} and G_{ξ} are compressed to values of σ_{ζ} and σ_{ξ} respectively, thereby obtaining the new maximum probability scale value m′_{maxζ} and m′_{maxξ}.

In the case of simulation of deep learning using an algorithm, the maximum probability value Φ_{maxζ} and Φ_{maxξ}, and the maximum probability scale value m′_{maxζ} and m′_{maxξ} are mapped to the data set layer or output data of the neural layer as mapping data.

The maximum probability value Φ_{maxζ} or Φ_{maxξ} and the compressed probability scale m′_{maxζ} or m′_{maxξ} will be mapped to the mapping layer or output layer as the mapping data. As long as the sample data falls between the maximum probability value Φ_{maxζ} or Φ_{maxξ} and the compressed probability scale m′_{maxζ} or m′_{maxξ}, it can be regarded to belong to this Gaussian distribution G_{ζ} or G_{ξ}. If the sample eigenvector SP_{ζ} conforms to the following formula 20, it can be considered as a data set belonging to Gaussian distribution G_{ζ}.

Φ_{max ζ}−m′_{maxζ}≤SP_{ζ}≤Φ_{maxζ}+m′_{maxζ} Formula 20

The following is about image_Net image classification problem, specifically introduces the algorithm simulation deep learning method proposed by the invention.

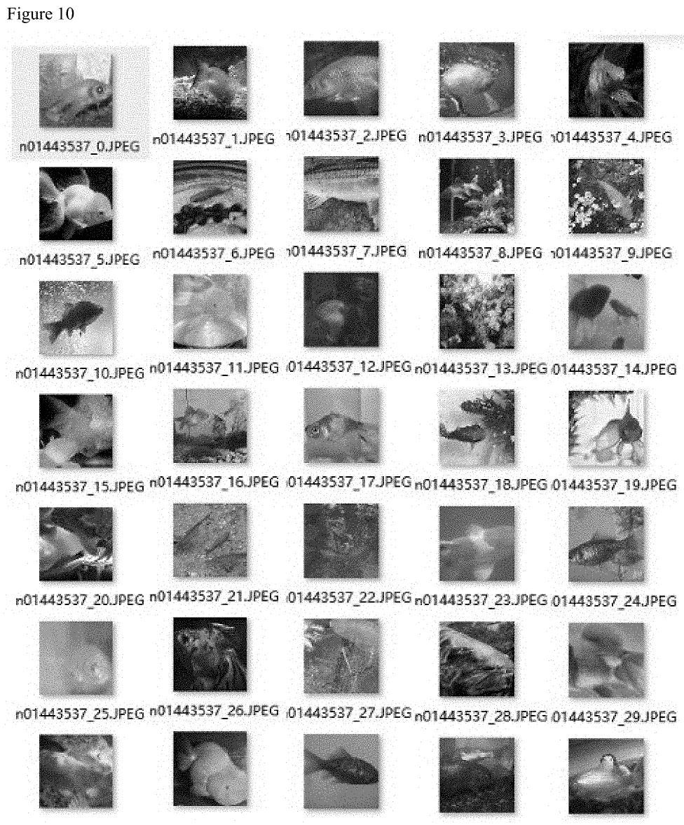

FIG. 10 shows the same class training data in data set of image_Net. As shown in FIG. 10, this is the training data of goldfish image. In order to achieve a higher accuracy image classification effect, the object image should be dug out from the background by artificial methods. For example, the object image in FIG. 10 is a goldfish, so it is necessary to dig out the goldfish image by manual method. This is also the process of human intervention to tell the machine what the object image is.

The following is to find the eigenvector of object image, which can be used to the gray value, the maximum probability value, the maximum probability scale, the maximum gray value, the minimum gray value and so on of gray information, in the R, G, B, or Lab of the a, b, or other color spaces. Or the texture information of the image can be obtained by calculating the derivative, and so on, to generate a variety of object image features, and can distinguish other types of object image feature vector generation method.

As shown in FIG. 10, even if the object image is goldfish, there are goldfish or other type of fish. Therefore, it is necessary to classify goldfish according to the probability space of the maximum probability.

The clustering algorithm based on SDL model is as follows:

Algorithm 1 SDL clustering algorithm

```
Input: V(C) (h=1,2,...,ρ) All eigenvalues in a given region C
Output: C(k) ( k=1,2,...,n )
for i ← 0 to 1 do//Find two initial probability spaces
for m ← 0 to μ do// The Probability scale self-organization is used to obtain two
maximum probability values
A{G^{(m)}[V(C)]} ← G{ A {G^{(m)}[V(C)]} ,M{G^{(m)} [V(C)] ,A^{(m)} [V(C)] }
if[A^{(m)} − A^{(m+1)}]² ≤ δ then//If less than the threshold, terminate
  break
end if
end for
A⁽ⁱ⁾ = A// The maximum probability value of two probability spaces
end for
for m ← 0 to 1 do//According to the principle of proximity, all data are divided into
two categories
        by two maximum probability values
G^{(m)} [V(C)] ← G{ A {G^{(m)}[V(C)]} , M{G^{(m)} [V(C)] ,A^{(m)} [V(C)] }
end for
for i ← 0 to 1 do// The maximum probability scale is reduced so that there is
      no coincidence part between the two probability spaces
for j ← 1 to 1 do
  if[M⁽ⁱ⁾ < M^{(j)}] M^{(j)} ← M^{(j)}*0.95// The probability scale of probability space
          with large probability scale is reduced
  else M⁽ⁱ⁾ ← M⁽ⁱ⁾*0.95
  end for
end for
for i ← 0 to 1 do// It has been divided into two class
  C⁽ⁱ⁾ [V(C)] ← G{ A {G⁽ⁱ⁾[V(C)]} ← , M{G⁽ⁱ⁾ [V(C)] ,A⁽ⁱ⁾ [V(C)] }
end for
num ← ρ −sizeof( C⁽⁰⁾[V(C)] ) −sizeof( C⁽¹⁾[V(C)] )//Number of remaining
vectors
size ← 2// The number of classes that have been processed so far
while num>0 do//numIs the number of vectors to process. If it is greater than 0, processing
continues
  for m ← 0 to μ do// Probability scale self-organization is used to find the
maximum probability value
        and scale of the new probability space
    A{G^{(m)}[V(C)]} ← G{ A {G^{(m)}[V(C)]} ,M{G^{(m)} [V(C)] ,A^{(m)} [V(C)] }
    if[A^{(m)} − A^{(m+1)}]² ≤ δ then//Less than threshold end
  break
    end if
    end for
for i ← 0 to size do// Compared with the previously processed probability space,
        the probability scale is reduced in the new probability space.
  if[M⁽ⁱ⁾ < M] M ← M*0.95
  end if
end for
// Finding the data within the scale according to the new probability scale
C^{(size)} [V(C)] ← G{ A {G⁽ⁱ⁾[V(C)]} , M{G⁽ⁱ⁾ [V(C)] ,A⁽ⁱ⁾ [V(C)] }
size ← size+1// Newly processed space increased by 1
num ← num − sizeof(C^{(size)} [V(C)])// Remaining quantity update
end while
Note:
    A- Maximum probability value
M- Probability scale
G- Probability space
```

The traditional K-means clustering is based on Euclidean distance, so it can't classify the probability space. And the number of classification needs to be specified in advance, so it can't get the best classification result in the probability space, and can't obtained the Gaussian distribution of the maximum probability of the objective function. K-means algorithm can not consider the characteristics of objective function mapping and Gaussian distribution of objective function.

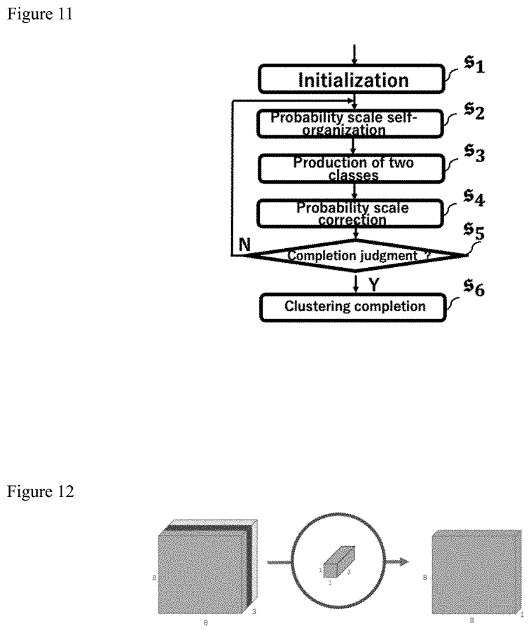

FIG. 11 is the Flow chart of clustering algorithm for SDL model.

As shown in FIG. 11, this is a clustering method with simulation deep learning by SDL model. Its characteristics are that the data training does not need to be combined and there is no black box problem. In terms of the effect of function mapping and Gaussian distribution, the best clustering results can be obtained autonomously. For the feature vectors of classes with small interval, the feature mapping of objective function can also be used to accurately obtain the recognition results. At the same time, for the image of FIG. 10 image_NET data, as color and texture are very simple image, it can maximize the generalization ability of Gaussian distribution model. This clustering algorithm can obtain the best fusion result of function mapping model and Gaussian distribution model for given training data and given feature vector extraction results.

As shown in FIG. 11, the specific steps of probabilistic spatial clustering are as follows:

STEP1 Initialization step: Respectively set up the database that has not been clustered [symbol] , and the clustered database [symbol] . At first, the feature vector data of all training data involved in clustering are put into

[symbol]

STEP2 Probability scale self-organization: Carry out probability scale self-organization iteration according to Euclidean distance between eigenvectors based on the data of [symbol] , obtain a constant that can represent the maximum probability Gaussian distribution [symbol] (maximum probability space), namely the maximum probability value Φ_{max ζ} (expected value) and the maximum probability scale mₘₐₓ (variance), then put the data eliminated in the iteration back into the database [symbol] , apply probability scale self-organization iteration once again against all data of [symbol] , obtain another maximum probability value and maximum probability scale (variance), and simultaneously put the data eliminated in the iteration back into the database [symbol] .

STEP3 Production of two classes: Because the eigenvector corresponds to a high-dimensional space, the clustering based only on Euclidean space distance will fall into the local optimal solution, so the following processing is required: Take the maximum probability value Φₘₐₓ as the center and combine with the maximum probability scale mₘₐₓ to construct the probability space and with all data in the database [symbol] to calculate the probability space distance. Confronted in these two probability spaces, the data within the two maximum probability scales mₘₐₓ are taken as the initial two clustering results.

STEP4 Probability scale correction: For the newly generated two Gaussian probability spaces, the maximum probability scale should be compressed with the probability spaces of different training set data in the database [symbol] , and a pair of compressed probability distribution data should be stored in the database [symbol] as the result of function mapping data set, so as to maximize the high recognition accuracy of function mapping and retain the maximum generalization ability of Gaussian distribution.

STEP5 Clustering completion judgment: Judge whether all eigenvector data have obtained clustering results, for “Y”, finish clustering, and for “N”, jump to STEP2 Probability scale self-organization.

Step 6 Clustering completes the steps.

The mapping mechanism of the objective function of deep learning is to focus on expanding the space of mapping data, that is, through the combination of complex neural networks, the training value of big data can be correctly recognized even if the distance between the feature vectors of different classes of the images is very small. Because each recognition object has to be mapped to the data set, the generalization ability is very poor. It is necessary to label all the states of the object image through big data before it only can be applied in practice.

The mechanism of the Gaussian distribution model has a very strong generalization ability by the training of small data, and it is necessary to increase the extraction quality of the feature value in order to improve the accuracy of image discrimination, and to increase the distance between the feature vectors of the different classes of images as much as possible, and to improve the accuracy of the image, however, there is a limitation.

The Gaussian distribution model has very strong generalization ability, but if the distance between the feature vectors of different classes of images is not large enough, the quality of the extraction of feature vectors cannot be guaranteed, and different classes of image data will be mixed into the probability space of the object image as resulting false recognition.

What is claimed is:

1. A clustering method based on Self-Discipline Learning SDL model has at least one of the following characteristics:
(1) The feature vectors are clustered according to the scale of probability space distance;
(2) The clustering results of each class are based on the maximum probability scale of the probability space.

2. A clustering method based on Self-Discipline Learning SDL model according to claim 1, which is characterized in that: the clustering algorithm of SDL model is the fusion of function mapping model and Gaussian distribution model; the optimal clustering of feature vectors is carried out through the probability scale self-organization and the distances of probability space; the clustering of the results of each probability space of the eigenvalue is directly given;
the clustering algorithm of the SDL model is the fusion of the function mapping model and the Gaussian distribution model. The clustering algorithm of the SDL model is used to get the best solution between function mapping model and Gaussian distribution model.

3. A clustering method based on Self-Discipline Learning SDL model according to claim 1, which is characterized in that the mapping function refers to: including linear function, non-linear function, random function, at least one of various mixed mapping functions.

4. A clustering method based on Self-Discipline Learning SDL model according to claim 1, which is characterized in that the mapping function refers to not only the classical linear function, the classical nonlinear function, the classical random function, especially according to the characteristics of the solution solved by the deep learning SDG, considering the effect of deep learning on improving the accuracy of pattern recognition The mapping function includes the components of mathematical operation form, membership function, rule construction component, at least one clustering component of SDL model, or a mixture of multiple components.

5. A clustering method based on Self-Discipline Learning SDL model according to claim 1, which is characterized in that the probability space of the maximum probability withe maximum probability value and the maximum probability scale value is obtained by the probability scale self-organizing algorithm.

6. A clustering method based on Self-Discipline Learning SDL model is realized through the following steps:
(1) The maximum probability value and maximum probability scale of the two maximum probability Gaussian distributions are obtained by using probability scale self-organizing iteration according to Euclidean distance between eigenvectors;
(2) The two maximum probability values obtained above are taken as the center, and all the data not clustered within the two maximum probability scales are regarded as the final two clustering results;
(3) Repeat the above processing until all data are clustered.

7. A clustering method based on Self-Discipline Learning SDL model according to claim 6, which is characterized in that: the clustering algorithm of SDL model is the fusion of function mapping model and Gaussian distribution model; the optimal clustering of feature vectors is carried out through the probability scale self-organization and the distances of probability space; the clustering of the results of each probability space of the eigenvalue is directly given;
the clustering algorithm of the SDL model is the fusion of the function mapping model and the Gaussian distribution model. The clustering algorithm of the SDL model is used to get the best solution between function mapping model and Gaussian distribution model.

8. A clustering method based on Self-Discipline Learning SDL model according to claim 6, which is characterized in that: the clustering algorithm of SDL model is the fusion of function mapping model and Gaussian distribution model; the optimal clustering of feature vectors is carried out through the probability scale self-organization and the distances of probability space; the clustering of the results of each probability space of the eigenvalue is directly given;
the clustering algorithm of the SDL model is the fusion of the function mapping model and the Gaussian distribution model. The clustering algorithm of the SDL model is used to get the best solution between function mapping model and Gaussian distribution model.

9. A clustering method based on Self-Discipline Learning SDL model according to claim 6, which is characterized in that the mapping function refers to not only the classical linear function, the classical nonlinear function, the classical random function, especially according to the characteristics of the solution solved by the deep learning SDG, considering the effect of deep learning on improving the accuracy of pattern recognition The mapping function includes the components of mathematical operation form, membership function, rule construction component, at least one clustering component of SDL model, or a mixture of multiple components.

10. A clustering method based on Self-Discipline Learning SDL model according to claim 6, which is characterized in that the probability space of the maximum probability withe maximum probability value and the maximum probability scale value is obtained by the probability scale self-organizing algorithm.
